(19) United States
(12) Patent Application Publication
(10) Pub. No.: US 2024/0289701 A1
(43) Pub. Date: Aug. 29, 2024

(54) VEHICLE-BASED MEDIA COLLECTION SYSTEMS AND METHODS

(71) Applicant: Ford Global Technologies, LLC, Dearborn, MI (US)

(72) Inventors: Lars Niklas Pettersson, Novi, MI (US); Furkhan Syed, Farmington Hills, MI (US); Samuel Johnson, Caliente, NV (US); Sasikumar Damodaran, Westland, MI (US); Michele Snipes, Canton, MI (US)

(73) Assignee: Ford Global Technologies, LLC, Dearborn, MI (US)

(21) Appl. No.: 18/173,538

(22) Filed: Feb. 23, 2023

(51) Int. Cl. G06Q 10/0631

(52) U.S. Cl. CPC G06Q 10/0631

(57) ABSTRACT

Vehicle-based media collection systems and methods are disclosed herein. An example method includes receiving a request to obtain media from a camera positioned on a vehicle, receiving a request to dispatch the vehicle for a Vehicle-as-a-Service (VaaS) service along a route, receiving media obtained by the camera as the vehicle it traverses the route, and transmitting the media to a computing device to a recipient.

### BACKGROUND

Sharing privately owned autonomous vehicles for use in rideshare services may be a lucrative way for vehicle owners to generate revenue. For example, the owner can offer their vehicle to a rideshare service when it is not in use, such as overnight (the owner can select any time). When the owner places the vehicle in service, the vehicle can be dispatched to transport riders on various trips. However, the owner may desire to confirm that their vehicle is being used in an agreed-upon manner while being borrowed. If the owner is not able to verify the proper (e.g., authorized) use of their vehicle, the owner may be less inclined to allow the vehicle to be used in the rideshare service.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example environment in accordance with one or more embodiments of the present disclosure.

FIGS. 2-5 collectively depict a flowchart of example methods of the present disclosure.

FIG. 6 is a flowchart of another example method of the present disclosure performed at the vehicle or service provider level.

### DETAILED DESCRIPTION

### Overview

Disclosed are autonomous vehicle (AV) rideshare media collection systems and methods. In general, an AV can be instructed to collect media, such as images and video as it traverses a route during a trip. These features can allow an owner of a vehicle to receive media during times when the AV is being used for rideshare services. The systems and methods can be used in any scenario where a vehicle can collect media during a trip. For example, a service provider can request vehicles to obtain media from particular locations or along particular routes. For example, a travel services company could obtain media from AVs that can be used to provide customers with pictures or videos of various routes.

A vehicle owner may request AV rideshare vehicle route media via a smartphone application. The application may be used to store media and link the media to the owner's phone, email, social media, or other account/record. The application may provide the option to acquire real-time in-route photos or stored photos (for later viewing), as well as video. The application may ensure the rider is informed that vehicle cameras may be taking outside pictures along the route.

The location or focus of the cameras on the vehicle may be optimized to acquire the best snapshots along the vehicle route. Dates, time stamps, and location information may be associated with each captured image/videos. The application may show the user the vehicle route and may allow them to establish locations along the route at which to capture images. An example system may also be configured to learn optimal spots along the route to capture images. For example, an algorithm may be used to automatically detect environment objects by their geometric shape or orientation (for example, sunsets, skylines, and tree lines, in relation to known architectures) and select the best points at which to capture images along the route.

Map-generating companies may publish back-end requests to an AV rideshare vehicle route calculator (e.g., service provider) to capture specified pictures from certain drive routes. Photo detection software or vehicle-to-vehicle (V2V) information may be used to anticipate the need to pictures of an event. V2V Infrastructure information involving another vehicle may be used to review snapshots to determine if any would be useful as evidence in the case of an event. In some instances, images of a vehicle can be obtained from adjacent vehicles or infrastructure-mounted cameras. These images of the vehicle can be used in combination with the images and/or location information obtained by the vehicle as verification or confirmation of vehicle location and/or action.

These systems and methods provide numerous advantages which include, but are not limited to, providing peace of mind for a vehicle owner as to how a VaaS (Vehicle as a Service) is using their vehicle. These systems and methods provide data that confirms to the vehicle owner that the customer is using the vehicle as intended and confirms that the customer (if a rideshare service is being provided) is on the planned route.

Ride-share vehicle owners can obtain real-time feedback on how the borrowed/rented vehicle is being used, with some configurations enabling the provision of real-time video directly to the mobile device of the owner. These features also hold the customer or VaaS provider accountable for the intended usage of vehicle share. The systems and methods herein provide the vehicle owner a future option to select favorite routes for themselves based on stored snapshot photos from borrowers' routes taken already, as well as establish or optimize future trip routes based on past snapshot photos.

### Illustrative Embodiments

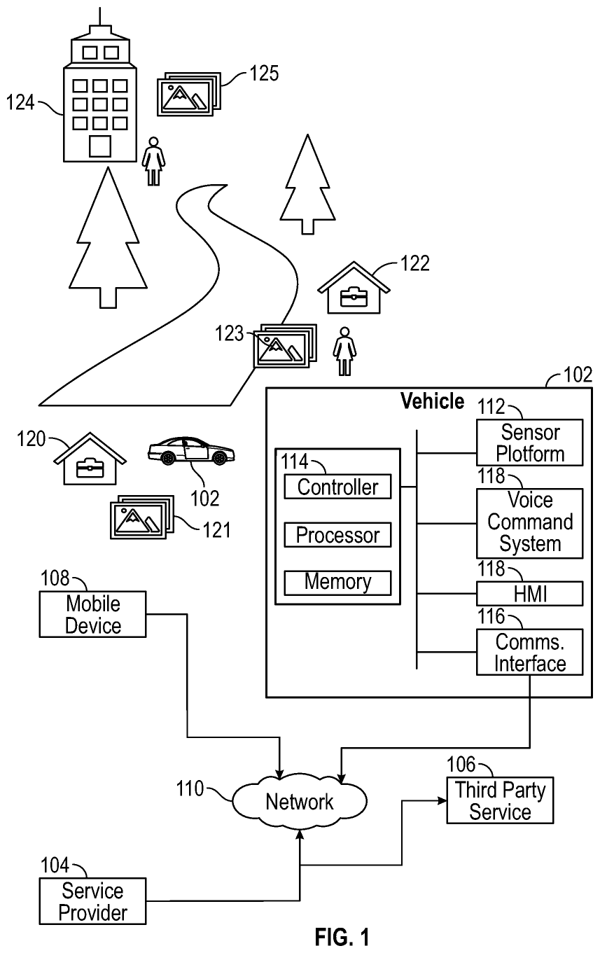

FIG. 1 illustrates an example environment where aspects of the present disclosure may be practiced. The environment includes a vehicle 102, a service provider 104, a third-party service 106, a mobile device 108, and a network 110. The network 110 may include any one or a combination of multiple different types of networks, such as cable networks, the Internet, cellular networks, wireless networks, and other private and/or public networks. In some instances, the network 110 may include cellular, Wi-Fi, or Wi-Fi direct. In other embodiments, components of the environment can communicate using short-range wireless protocols such as Bluetooth™, near-field communications, infrared, and the like.

The vehicle 102 can include an AV, a connected vehicle having semi-autonomous capabilities, or a legacy vehicle that is manually operated by a driver. In one scenario, when the vehicle is an AV, an owner of the vehicle can place the vehicle into service for use in rideshare services. The owner can establish the parameters for use of the vehicle with the service provider 104. For example, the owner can use an application on their mobile device 108 to select the usage parameters, such as the hours of the day the vehicle can be used for autonomous transport services, such as package delivery or ridesharing. The service provider 104 can dispatch the vehicle for trips during the hours specified by the vehicle owner. The vehicle is equipped with cameras that are used to obtain images/video as the vehicle completes trips.

In another scenario, the vehicle is an AV that belongs to a fleet of AVs controlled by the service provider 104, but the vehicles may not be owned by private individuals. The service provider 104 can dispatch the vehicles based on rideshare or package delivery requests from riders/recipients. The vehicle is equipped with cameras that are used to obtain images/video as the vehicle completes trips.

In yet another scenario, the vehicle is not equipped for autonomous operation but is equipped with cameras that are used to obtain images/video as the vehicle is driven. The vehicle can report its trip data from a navigation system. Third parties or other entities can specify locations or routes along which they would like to obtain media. If the service provider identifies that a route that will be traversed by the vehicle corresponds to a location or route that was specified by a third party, the service provider can request that the vehicle obtain media from the location(s) or route(s). In yet another example, the vehicle could be a rental car that is operated by a renter. The vehicle can obtain images during the rental period and the renter can request images or videos obtained by the vehicle. For example, the renter may obtain a vehicle on their vacation or road trip. Images obtained on the road trip can be accessed by the renter. The rental car company could obtain these images or videos and sell the same to the renter or to another service, such as a map service. As noted above, captured pictures (sequences) or videos from select locations or part of a trip route can be sold to map-generating companies (third-party service) as updates mapping services, as well as to fleet owners additional revenue opportunities. An ecosystem of AVs/ride-share vehicles can be equipped with certain specific camera systems to capture a desired quality or type of data instead of specialized vehicles used by mapping companies. Such companies can also publish back-end requests to the service provider 104 (AV/ride-share route calculating system) to have vehicles traverse routes for which they need (updated) pictures/picture sequences.

Also, the vehicle can be configured to periodically or continually obtain images/video that can be used as evidence in motor vehicle events or to catalog vehicle use in general. Regardless of the intended use, the vehicle can obtain media and relay the same to a recipient. In some instances, the vehicle can be configured to use image recognition or photo detection features to identify objects or locations of interest and obtain media of the same. Also, the vehicle can be configured to employ algorithms that can auto-detect environment objects by their geometric shape or orientation (i.e., sunsets, skylines, tree lines, in relation to known architectures and select the best scenes/scenery to take photos along the route).

In general, the vehicle 102 can comprise a sensor platform 112, a controller 114, and a communications interface 116 for connecting to the network 110. The vehicle can also include a human-machine interface 118 that can be used to present media to an occupant. The sensor platform 112 can include any sensor that can collect vehicle-related data such as a current vehicle location and cameras that can obtain images and/or video. The cameras can be positioned around the periphery of the vehicle. In some instances, the vehicle can include one or more roof-mounted wide-angle cameras and one or more 360-degree Cameras. Some cameras may have a defined field of view that is less than 360-degrees. The cameras can be placed at varying heights around the vehicle. In some instances, the cameras are controllable such that their directionality and/or field of view can be adjusted based on signals from the vehicle controller 114. For example, a camera can be associated with an adjustable mount that can be controlled via signals from the controller 114. Stated otherwise, the controller 114 can transmit a control signal to the camera to adjust a position of the camera to change a field of view of the camera.

The controller 114 includes a processor and memory, and the memory stores instructions that can be executed by the processor. In general, the controller 114 can be configured to obtain media captured by vehicle sensors based on various conditions or requests. The media can be transferred to the service provider 104, the third-party service 106, and/or the mobile device 108, as will be discussed in greater detail herein. The controller 114 can also be configured, generally, to determine location information for the vehicle, as well as communicate with the service provider 104 to obtain instructions related to the collection of media and/or rideshare services. In some instances, the controller 114 can communicate with other vehicles (V2V) and/or infrastructure elements (V2X) to request media from other cameras not located on the vehicle. To be sure, example scenarios and implementations will be provided herein.

In some configurations, the controller 114 can create a link between a camera of the sensor platform 112 and the mobile device 108. This can include a direct communications link when the camera is equipped with a dedicated communications interface, or a link that is indirect through the controller 114.

The service provider 104 can include, for example, a backend server that can be configured to provide a service, such as a rideshare or other vehicle-mediated services such as package delivery or information gathering. In one example, the service provider 104 can receive ride requests from a user and dispatch the vehicle 102 for an autonomous trip. In another example, the service provider 104 can dispatch the vehicle 102 to obtain media of a particular location or along a particular route. The service provider 104 could receive a request to obtain images of locations along a route for a map or travel service (e.g., an example third-party service). In another example, a user could dispatch their vehicle to autonomously navigate to a location and obtain images or video of the location.

When a vehicle has been placed into service for any particular purpose where the vehicle may be used without the owner being present, the owner of the vehicle can request that the vehicle obtain media during its unattended use through an application on their mobile device 108. The owner can indicate if they would like media collected, what types(s) of media to collect, the frequency of media collection (e.g., every five minutes for example), or the specific locations where media are to be obtained. Additionally, the owner can specify whether they would prefer to receive real-time media from the vehicle and/or if media should be stored for later viewing. That is, the images can be stored at the service provider 104 for subsequent access by the owner.

In some instances, the vehicle controller 114 can receive instructions from the service provider 104 that affect how media is obtained by the vehicle. For example, the service provider 104 can instruct the vehicle controller 114 to obtain images at locations specified by the owner of the vehicle. During a trip, the vehicle controller 114 can track the current location of the vehicle using GPS (for example) and determine when the vehicle has reached certain locations where images are desired. The vehicle controller 114 can cause the cameras of the vehicle to take pictures when the vehicle reaches the location(s). The owner can specify a preference that the vehicle obtains pictures while moving or when stationary, such as at a stoplight. The owner can also specify if they want panoramic images, or only images obtained from other types of cameras on the vehicle (e.g., side-view, front-view, rear-view, or combinations thereof).

Additionally, when a user, such as a rideshare customer is using a vehicle that may be obtaining media during a trip, the user can be informed by the service provider 104 or the vehicle controller 114. For example, the service provider 104 can inform the user prior to them accepting the trip. The service provider 104 could provide a message to the user through their mobile device or application that is used to request a ride. The user can also be informed again prior to entering the vehicle or once they are in the vehicle. For example, the vehicle controller 114 can transmit a signal to the mobile device of the user that reminds them that media will be obtained during the trip. In another example, the user could be reminded by a message presented on an in-vehicle display or through a voice command feature of the vehicle.

In one non-limiting example, the vehicle 102 can be dispatched by the service provider 104 from a home 120 of a vehicle owner. The vehicle owner has previously consented to allow the vehicle to be used in a VaaS controlled by the service provider 104. The owner has also previously established the rules for when media is to be obtained and how it is to be delivered to the mobile device 108 of the owner. In this example, the vehicle controller 114 can cause one or more cameras of the vehicle to a first set of images 121 when the vehicle leaves the owner's home 120. The vehicle can obtain a second set of images 123 when the vehicle arrives at a designated location 122 to pick up the rider. For example, the vehicle controller 114 can identify that the vehicle has arrived at the designated pickup location based on GPS signals.

When the vehicle has arrived, the vehicle controller 114 can obtain a third set of images 125 of the pickup location, which in this instance includes the rider's home. The vehicle controller 114 can wait to obtain images until the rider is securely inside the vehicle so as to protect the identity of the rider. This can include identifying when the vehicle door has been opened and closed, as well as when a seatbelt of the vehicle has been engaged. Any method for detecting that a rider is within a vehicle can be used, such as facial recognition, and the like.

The vehicle controller 114 can obtain images each time the vehicle comes to a stop, such as when the vehicle is at a stop sign or when stopped at a streetlight. Again, the vehicle can be moving or stationary when images are obtained. The vehicle controller 114 can obtain images when the vehicle arrives at a destination 124. Again, these images can be obtained prior to, or after the rider has exited the vehicle. Images can also be obtained as the vehicle navigates back to the home 120 of the owner. The images obtained during the trip can be provided in real-time to the mobile device 108 of the owner. These images can also be stored at the service provider 104 level for later access by the owner.

Again, this example is not intended to be limiting and the vehicle controller 114 can obtain images or video at any time during a trip, regardless of the purpose of the trip. The number or types of media obtained are selectable and can be collected in an automated manner. These media can be stored at the vehicle level, the service provider level, or transmitted in real-time to a recipient without storage at any level.

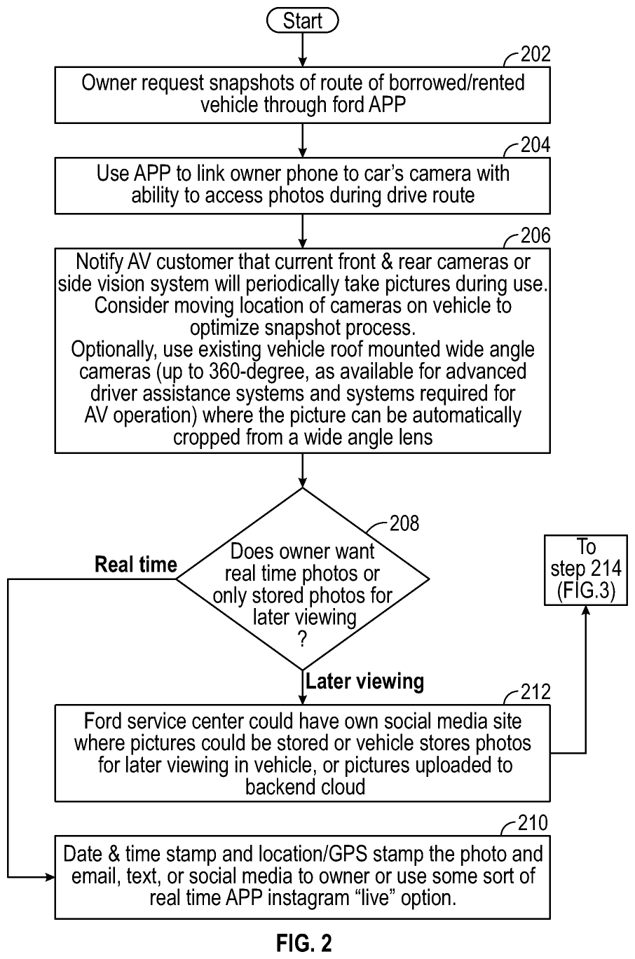

FIGS. 2-5 collective illustrate a flowchart of example methods of the present disclosure. In FIG. 2, the method can include a step 202 of an owner requesting snapshots (other media can be requested as well) of a route of a borrowed vehicle through an application on their mobile device. For example, FORD provides a PASS application that can be executed by any mobile device. As noted above, the owner can establish media collection parameters that can identify when the media is collected during a trip, what type or types of media are collected, how the media are transmitted back to the owner, and/or if the media is to be stored offline.

In step 204, the method can include linking the mobile device of the owner to a camera of the vehicle. This can include providing the owner with the ability to adjust the media collection parameters in real time, as well as receive media in real-time. As noted above, this linkage can be a direct communicatively link with the camera when it is equipped with hardware that allows it to access the network. The linkage can also be indirect and mediated through a communications link established between the controller of the vehicle and the mobile device. In yet another example, the linkage can be indirect and mediated through a communications link established between the controller of the vehicle and the service provider. The service provider relays media to the mobile device through the application.

In step 206, the method can include notifying a user, such as a rider or other person who is not the vehicle owner, that various cameras on the vehicle may be used during their trip. The user can be notified that media may be captured during the trip periodically (or continuously). The message to the user can be provided prior to entering the vehicle or at ride booking so that the user can decide to cancel or accept the service. In some instances, the user can be requested to adjust vehicle cameras for optimal viewing. The user can be compensated for this help in some instances, such as a reduction in ride fare.

As noted above, various cameras can be used to obtain images such as roof-mounted cameras, wide-angle cameras, and other similar cameras. To be sure, 360-degree, wide-angle cameras may be present on many vehicles having ADAS (Advanced Driver Assistance Systems) features. These systems are typically present in autonomous vehicles. In some instances, wide-angle images can be obtained and cropped if requested by the owner. The controller can automatically divide a panoramic image into several images.

In step 208, the method can include determining if the owner desires real-time media or stored media. Again, this can be defined by the owner in step 202, but the process proceeds to step 210 of stamping each image with a date and time, as well as a GPS location. The stamped image can be transmitted via email, text, social media, directly to the mobile device, or to any application programming interface (API) that provides the images to a platform.

However, in step 212, if the owner does not want real time media but would instead prefer to have the media stored for subsequent access, the media can be stored in a social media platform operated by the service provider, stored at the vehicle level, or to a backend cloud or server. In one example, if the images are stored locally at the vehicle, the images can be accessed through an infotainment system of the vehicle. The images could be relayed to the mobile device of the owner when the vehicle returns to the home of the owner and connects to a local network of the home.

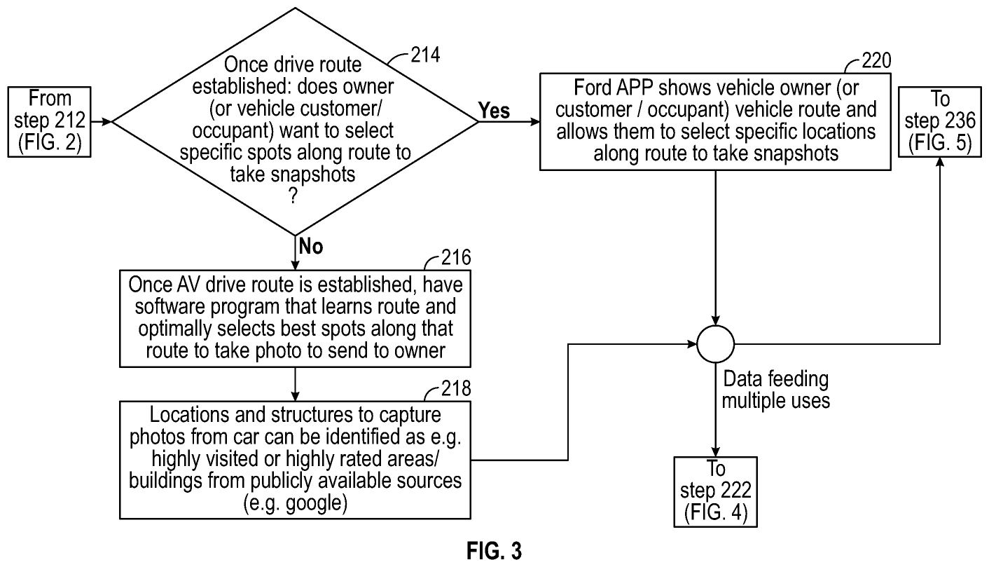

The method continues to FIG. 3 where in step 214, a determination is made once a route has been established as to whether the owner (or vehicle occupant or third party) wants to select specific locations along the route where photos should be taken and transmitted to the owner. If the owner does not want to select the locations, some non-limiting options may be pursued. A driving route can be established from a rideshare request or GPS information obtained from a vehicle navigation system.

For example, in step 216, once a driving route has been established (could be a route for an AV or a legacy vehicle), the controller can be configured to evaluate the route and optimally select the best locations/spots along that route to take a photo to send to the owner. This could include consulting a map to look for common points of interest, buildings, or other discernable or recognizable landmarks. As noted in step 218, the controller can determine locations and structures to capture media from highly visited or highly rated areas/buildings, and landmarks. The data on what is considered to be highly visited or highly rated could be determined from an online resource or a third party. The data could be crowdsourced as well, from other owners and users of the vehicle(s) in the VaaS. If the owner does desire to select the locations where images are to be obtained, the method can include a step 220 where an application on a mobile device (or an HMI of a vehicle as another alternative) presents the owner (or any other user) the vehicle route and allows them to select the specific locations along the route where images can be obtained. For example, the owner could drop pins in locations along the route.

Once the media and/or other data such as location data are collected, these data can be date, time, and location stamped so that the media can be identified and categorized at a later point. As noted above, the media can be transmitted to the owner in real-time, stored for later use, or combinations thereof.

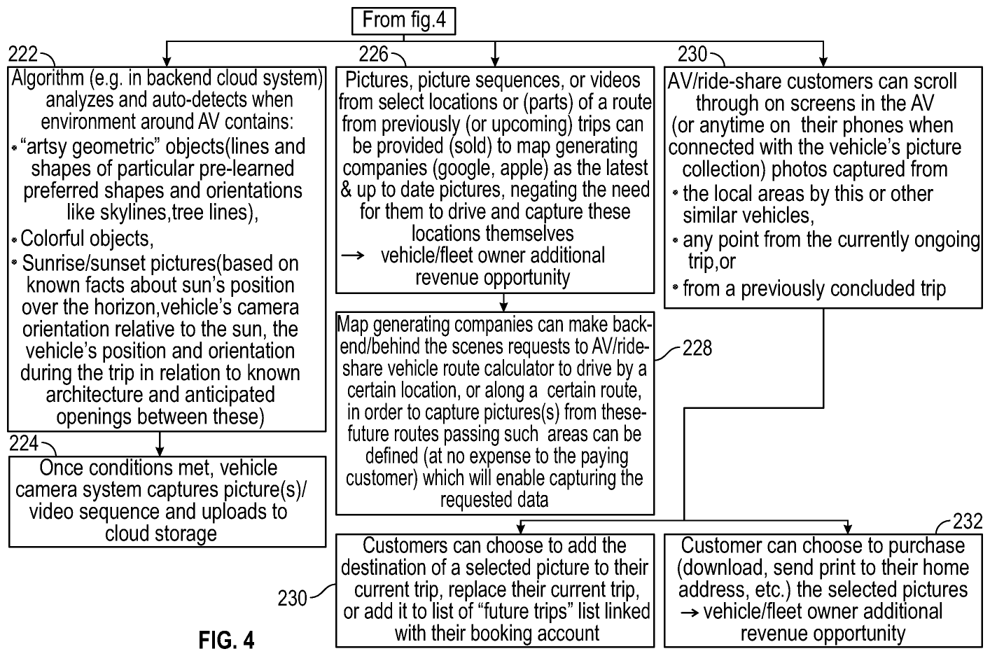

The method continues to FIG. 4 where in step 222, a service provider can execute an algorithm to analyze and auto-detect when an environment around the vehicle contains any of the following. In this example, the vehicle obtains images from vehicle-mounted cameras and transmits the images over a network to the service provider. The service provider can then evaluate the images with photo detection, facial recognition, or other image processing algorithms to identify objects of interest by shape and/or orientation such as trees, buildings, landmarks, or other physical objects. The images can also be evaluated for skylines, tree lines, cityscapes, and so forth. In some instances, colors of objects such as skylines can also be evaluated and captured, allowing for the capture of sunsets, sunrises, and other geophysical phenomena. With respect to sunrise and sunset images, these photos can be gathered based on known data such as Sun position relative to the horizon, the camera's orientation relative to the Sun, and/or the vehicle's position and orientation during a trip in relation to known infrastructure architecture and anticipated openings there between. For example, the controller of the vehicle can determine spans between tunnels where images can be obtained, as well as other conditions where the field of view may be limited such as travel over/under a bridge or overpass. Another example could include using the spatial relationships between buildings that create gaps where skyline images can be obtained without being obscured by the buildings. In general, the controller can detect obstacles or objects that may obscure camera views and wait until the vehicle is past these objects before obtaining additional snapshots.

The photos can also be captured and evaluated during various weather conditions to determine what locations or objects look like in varying conditions, as well as lighting conditions. For example, the images could be reviewed during both daytime and nighttime conditions and evaluated to determine if locations or roads are well-lit or not.

In general, algorithm-based conditions can be established for when and how images/videos are obtained. These conditions can be based on any suitable type of image analysis. Once conditions have been satisfied, the vehicle camera can be actuated to capture picture and/or video sequences and transmit the same to a recipient in step 224.

In step 226, another use case involves providing collected media, such as snapshots and/or video, obtained at selected locations of a route from a prior or ongoing trip, to a third party service such as a map-generating company. Because of the large number of available AVs that can collect data, the collected media are likely to be more up to date than the periodic data collected by dedicated vehicles used by the map-generating company.

In step 228, the method can include receiving a request from the map-generating company to request the service provider to dispatch a vehicle to traverse a route and obtain media. Again, this can be an AV that is dispatched solely to obtain media, or as a complementary part of a rideshare route. The service provider can determine upcoming or forecasted vehicle trips or routes for various AV vehicles in a fleet and determine that an AV in the fleet will pass by a location of interest. That is, a third-party may have requested an image of a location of interest from the service provider. That request can be matched to a ride request that includes the location of interest along the route that the user will take.

In step 230, another use case involves allowing a rideshare customer to scroll through images presented on an in-vehicle display that have been collected along their current route. The images can also include images obtained during prior trips where the AV has taken other customers on the same route. The images may have been captured by the AV or another AV in the fleet. In step 232, customers can choose to add the destination of a selected picture to their current trip, replace their current trip, or add a location associated with the picture to a future trip itinerary. For example, the customer can be presented with pictures of points of interest in the general geographical area or location. These may be pictures of places not currently on the customer's route, but the customer chooses these pictures to visit in the future. Because images are stamped with date, time, and/or location, the location of the selected point of interest can be added to their account. In step 234 the customer can be allowed to choose to purchase any of the pictures they selected. These pictures can be downloaded, emailed, printed, or otherwise used by the customer.

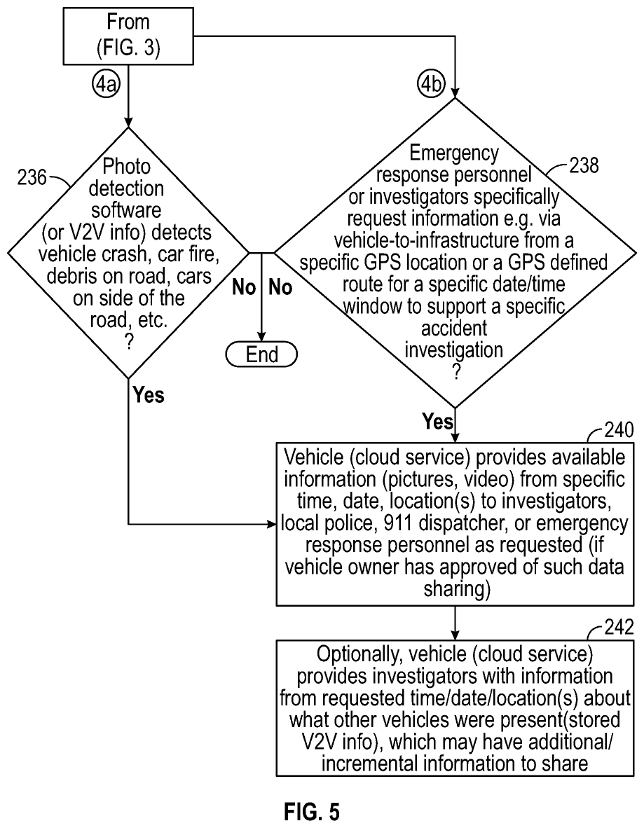

Referring now to FIG. 5, a step 236 involves the analysis of media captured by the vehicle cameras (or other vehicle cameras or infrastructure cameras, which are shared with the vehicle) that can be processed to detect vehicle-related events or events of interest occurring along the route. For example, the images can be processed to identify events such as traffic, special events such as runs or other events that affect the route, vehicles or objects on a road or on roadsides, and so forth. In step 238, vehicle response personnel or an interested party can receive media collected by the vehicle. These data can be shared over a V2X connection or other equivalent protocol. Additionally, the location of the vehicle and/or location where the media were obtained can also be defined in terms of GPS coordinates and shared with the vehicle response personnel or an interested party. In step 240, the vehicle (or service provider) can share any related information such as date, time, location, and other collected information associated with the media to a requesting party, assuming the vehicle owner has given permission for the same to be shared.

In step 242, the method includes the sharing of data related to other vehicles that may have been present near the vehicle when the media was obtained. This can include information gathered from the other vehicles over V2V connections. These data include images or videos of the same location obtained from other vehicles in the same general area that may have also captured images of the vehicle.

As noted above, media can be obtained of the vehicle by other vehicles that may pass the vehicle on the same route. Also, images of the vehicle can be obtained by an infrastructure camera that is located along the route. For example, an image of the vehicle can be obtained by a red light camera associated with a street light located on the route. These images can be obtained by the service provider and used to confirm that the vehicle was present and accounted for as it traversed the route. These images and confirmation can be shared with the vehicle owner to further enhance trust by the vehicle owner that their vehicle is being used in accordance with their expectations.

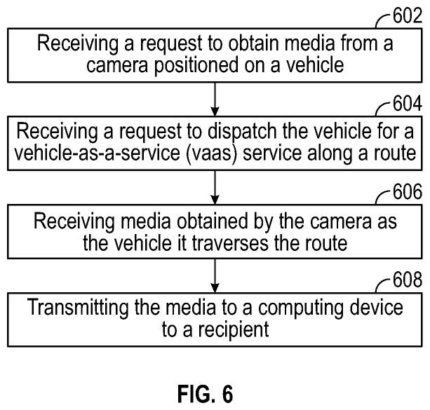

FIG. 6 is a flowchart of an example method of the present disclosure that can be performed by either a service provider or an equipped vehicle. The method can include a step 602 of receiving a request to obtain media using a camera positioned on a vehicle. As noted above this can include a request from an owner of the vehicle or from a third-party service. This request can be provided through an application or through an HMI of the vehicle.

Next, the method includes a step 604 of receiving a request to dispatch the vehicle for a Vehicle-as-a-Service (VaaS) service along a route. For example, a rideshare request can be received in order to dispatch the vehicle from its current location. The method can include a step 606 of receiving media obtained by the camera as the vehicle traverses the route. The media can be received by the vehicle itself and/or by a service provider who receives the images from the vehicle. The method can then include a step 608 of transmitting the media to a computing device to a recipient. As noted above, in some instances the media can be received by the mobile device of an owner of the vehicle directly from the vehicle (or camera), or the media can be transmitted to the mobile device from a service provider that received the media from the vehicle.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method comprising:
receiving a first request to obtain media using a camera positioned on a vehicle;
receiving a second request to dispatch the vehicle for a Vehicle-as-a-Service (VaaS) service along a route;
receiving media obtained by the camera as the vehicle traverses the route; and
transmitting the media to a computing device.

2. The method according to claim 1, further comprising receiving media collection parameters from an account associated with the owner of the vehicle, the media collection parameters identifying at least one of when or where the media is collected, what type or types of media are collected, and how the media are transmitted back to the account.

3. The method according to claim 1, further comprising providing a message to a rider of the vehicle that the vehicle will be obtaining media during the VaaS service.

4. The method according to claim 1, further comprising:
detecting a location or an object of interest while the vehicle is driving along the route; and
obtaining images or video of the location or the object of interest.

5. The method according to claim 1, wherein the media is transmitted to a mobile device of the owner in real-time.

6. The method according to claim 1, further comprising storing the media at a service provider for subsequent access by the owner.

7. The method according to claim 1, further comprising transmitting a control signal to the camera to adjust a position of the camera to change a field of view of the camera.

8. The method according to claim 1, further comprising creating a communications link between the camera and a mobile device of the owner.

9. The method according to claim 1, further comprising:
determining a location of the vehicle when an image is obtained, the image being part of the media; and
associating the image with a date and time stamp, as well as the location.

10. The method according to claim 1, further comprising obtaining additional media of locations, objects, or of the vehicle, by another vehicle traversing the route, the additional media being shared over a vehicle-to-vehicle connection.

11. The method according to claim 1, further comprising:
obtaining infrastructure media of the vehicle, by an infrastructure camera along the route; and
verifying that the vehicle was present on the route using the infrastructure media.

12. A system comprising:
a processor; and
a memory for storing instructions, the processor executing the instructions to:
receive a first request to obtain media from a camera positioned on a vehicle;
receive a second request to dispatch the vehicle for a Vehicle-as-a-Service (VaaS) service along a route;
received obtained media captured by the camera as the vehicle it traverses the route; and
transmit the media to a computing device to a recipient.

13. The system according to claim 12, wherein the processor is configured to receive media collection parameters from an account associated with the owner of the vehicle, the media collection parameters identifying when the media is collected, what type or types of media are collected, and how the media are transmitted back to the account.

14. The system according to claim 12, wherein the processor is configured to store the media for subsequent access by the owner.

15. The system according to claim 12, wherein the processor is configured to:
determine a location of the vehicle when an image is obtained, the image being part of the media; and
associate the image with a date and time stamp, as well as the location.

16. The system according to claim 12, wherein the processor is configured to:
obtain additional media of locations, objects, or of the vehicle, by another vehicle traversing the route, the additional media being shared over a vehicle-to-vehicle connection;
obtain infrastructure media of the vehicle, by an infrastructure camera along the route; and
verify that the vehicle was present on the route using the infrastructure media or the additional media.

17. A vehicle comprising:
a camera; and
a controller having a processor and memory, the processor executing instructions stored in the memory to:
receive a Vehicle-as-a-Service (VaaS) request to travel a route to a destination;
receive first instructions to obtain media along the route; and
transmit the media to a service provider over a network, wherein the media is transmitted to computing device of an owner of the vehicle.

18. The vehicle according to claim 17, wherein the controller is configured to provide a message to a rider of the vehicle that the vehicle will be obtaining media during the VaaS service.

19. The vehicle according to claim 18, wherein the controller is configured to:
detect a location or an object of interest while the vehicle is driving along the route; and
obtain images or video of the location or the object of interest.

20. The vehicle according to claim 19, wherein the controller is configured to transmit a control signal to the camera to adjust a position of the camera to change and optimize a field of view of the camera.
